(19) United States
(12) Patent Application Publication
(10) Pub. No.: US 2018/0001535 A1
(43) Pub. Date: Jan. 4, 2018

(54) BLOWING HEAD, METHOD FOR PRODUCING A BLOWN FILM AND BLOWN FILM INSTALLATION

(71) Applicant: Reifenhäuser GmbH & Co. KG Maschinenfabrik, Troisdorf (DE)

(72) Inventors: Holger SCHUMACHER, Sankt Augustin (DE); Bernd SCHROETER, Troisdorf (DE)

(21) Appl. No.: 15/546,388

(22) PCT Filed: Nov. 9, 2015
(86) PCT No.: PCT/DE2015/000535

§ 371 Date: Jul. 26, 2017

(30) Foreign Application Priority Data
Jan. 29, 2015 (DE) 10 2015 001 022.0

(51) Int. Cl. B29C 47/26; B29C 47/56; B29C 47/08; B29C 47/06; B29C 47/70; B29C 47/00; B29L 23/00

(52) U.S. Cl. CPC B29C 47/268; B29C 47/263; B29C 47/707; B29C 47/56; B29C 47/0026; B29C 47/085; B29C 47/065; B29C 47/0057; B29L 2023/001

(57) ABSTRACT

A blowing head, a method for producing a blown film, and a blown film installation include the use of plate spiral distributors in blown film installations for distributing melt steams arriving from extruders and for combining the melt streams to form an annular gap stream in several layers in an annular gap leading to a tubular die. The melt streams in a plate spiral distributor are initially bundled and then forwarded in a bundled manner to a common co-extrusion flow. The distributer has a plurality of spirals in superimposed layers, and the spirals of two layers have a junction for pre-combining the melt streams of two layers, and in that starting from the junction, a common guide leading to the annular gap is provided for combining there the pre-combined melt streams with the annular gap stream.

The invention refers to a blowing head for a blown-film plant, a method for manufacturing a blown film and to a blown-film plant.

Blown-film plants are well-known and have proven their worth in the state of the art.

In extruders, plastic granulate is liquefied and condensed, i.e. homogenized, by shearing. The plastic melt is fed to a blowing head through separate channels. In the blowing head, spiral distributors distribute the plastic melt, in separate layers, in an annular gap leading to an annular gap nozzle. From the annular gap nozzle, a multi-layer blown-film tube exits in the form of a melt, which then solidifies at a frost line and is subsequently laid flat, turned round, partially reversed and finally wound up.

There are two general types of blowing heads. The first are axial spiral distributors, embodied as conical spiral distributors or as cylindrical spiral distributors; the others are plate spiral distributors, which are frequently also called in the state of the art “stack die” or “pancake”, radial spiral distributor, or horizontal spiral distributor.

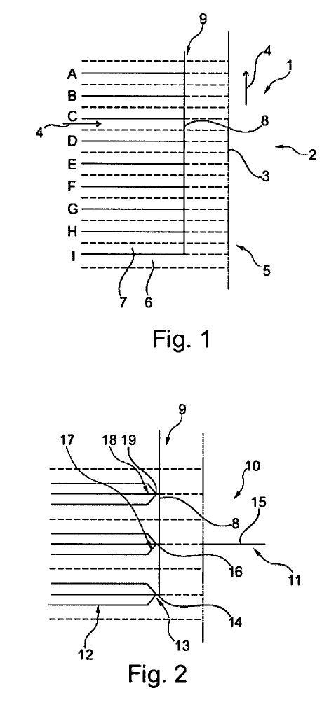

DE 102007 008844 A1 discloses a plate spiral distributor. The multi-layer film is formed from bottom to top, as is common in the state of the art. In the example of embodiment shown in FIG. 1, a five-layered film is created. The molten plastic mass is simultaneously pressed to form five plate packages, one plate package forming a spiral located on one level. Radially inward, the five melt streams exit into a central annular gap. In this way, first a one-layered flow is produced in the path from bottom to top. Radially around this flow, a second layer is placed coming from the second plate package, and this continues until at the end a five-layered flow leads through the central annular gap upward towards the tubular die and a five-layered film is blown out which has a tubular shape.

WO 2008/043715 A1 shows a plate spiral distributor in its FIG. 1 as well.

EP 1 550 541 B1 also discloses a plate spiral distributor in its FIG. 1; however, the rest of this invention relates to different types of spiral mandrel distributors and in its FIG. 4, it discloses only axial spiral distributors.

The present invention is based on the task of providing an improvement or an alternative to the state of the art.

In a first aspect of the present invention, this task is solved by a blowing head for a blown-film plant, having a plate mandrel distributor for distributing melt streams arriving from extruders and for combining the melt streams in a multi-layer annular gap stream in an annular gap leading to a tubular die, the plate spiral distributor having a plurality of spirals in superimposed layers, the spirals of at least two layers having a junction for pre-combining the melt streams of at least two layers, and a common guide being provided from the junction to the annular gap for combining there the pre-combined melt streams with the annular gap stream.

Some terms will be explained in the following. The invention is intended for multi-layer plate spiral distributors.

For producing several layers with different mechanical, tactile or aromatic characteristics or any other type of characteristics, normally different types of plastics are used for multi-layer films. Consequently, they are homogenized in various different extruders, especially by one extruder per layer or by one extruder per plastic.

The “annular gap” of a blowing head is normally exactly one annular gap which extends coaxially with an assembling direction and thus with an extrusion direction of the blowing head. The extrusion direction is normally from bottom to top with a vertical axis of the spiral distributor.

As a general rule, it is pointed out that within the scope of the present patent application, indefinite articles and numerals such as “one”, “two” etc. are usually to be understood as indicating a minimum, that is, “at least one . . . ”, “at least two . . . ” etc., unless it is indicated directly or indirectly by the context that, for instance, “exactly one . . . ”, “exactly two . . . ” etc. are intended.

The “superimposed layers” are normally spiral paths positioned on mutually parallel levels.

The path of the spirals is of relevance. Each spiral is supplied in the upstream direction by a pre-distributor. The pre-distributors cause the melt stream arriving from an extruder to branch out, generally into binary branches which can be located on one level, but which do not necessarily have to be on one level and especially not on the same level as the spiral which is supplied by them.

The expression “superimposed” refers to the layers succeeding each other in the extrusion direction. In a blowing head with vertical axis and therefore with an overall vertical extrusion direction, the “layers” are indeed positioned on top of each other with a vertically upward extrusion. However, other spatial positions are possible as well.

A “junction” is characterized by the fact that the spirals of two layers are joined so that during operation of the blowing head, a continued stream with at least two layers is formed there. In other words, at the junction, a pre-combination of two melt streams and thus of two layers is induced.

Finally, the pre-combined multi-layered stream is either pre-combined further or conducted to the annular gap.

The “annular gap stream” is the stream within the annular gap which is directed toward the tubular die.

The advantage of the invention proposed here is that the blowing head has more universal uses. If, for instance, a junction is adapted for two melt streams which are identical in terms of volume, the operator of the blown-film plant can also drive the junction, for instance, with a volume flow ratio from 1:3 to 3:1.

This is different from the direct junction of a relatively weak melt stream with the annular stream in the central annular channel, which has a much larger volume flow. This junction is known from the state of the art and with it, only much smaller processing windows can be driven.

Preferably, the spirals of exactly two adjacent layers have a junction.

This means that one or more junctions can be provided, but that at least one of the junctions, exactly two melt streams can be pre-combined to form a two-layered stream.

Alternatively or in addition, the spirals of exactly three layers, especially of adjacent layers, can form a junction.

In a preferred embodiment, a plurality of junctions is provided which have successive inputs to the annular gap.

By “successive input”, it is intended that the inputs of the channel guides leading from the junctions into the annular channel are offset in the extrusion direction, that is, during operation of the blowing head, they cause a successive formation of layers in the annular channel.

It is a particular advantage if the blowing head is structured so that only pre-combined streams, that is, channels with junctions, have an outflow into the annular channel. With such a construction, only pre-combined multi-layer streams are guided into the central annular channel so that even the last melt stream, that is, the melt stream guided into the strongest volume flow in the annular channel, is stronger than a simple one-layered inflow in the annular channel would be.

A plate of a plate spiral distributor can have a spiral each on its top and on its bottom side. The blowing head will then be particularly compact, especially if several or all plates with spirals have a spiral on their top and on their bottom sides each.

In a second aspect of the present invention, the task is a method for manufacturing a blown film by means of a blowing head as described above, wherein melt streams from extruders are conducted through the spirals and wherein two melt streams are pre-combined in a junction, whereupon in the further flow path, the pre-combined melt streams are conducted in the annular gap and joined there with the arriving annular gap stream.

It has already been explained that in a preferred embodiment, three melt streams are pre-combined in a junction, wherein in the junction an intermediate layer is provided with two covering layers and guided into the annular gap in the covered state. In such an embodiment, a relatively weak, for instance soft or very thin, layer can be securely combined also with an arriving annular stream with a high volume flow.

The two covering layers can be produced with the same plastic, for instance with the same thickness, wherein a symmetric structure of the pre-combined layers or of the film as a whole is often desirable, but not indispensable.

Naturally, the advantages of the method and of the blowing head introduced here also have direct advantageous effects on a blown-film plant as a whole.

In the following, the invention will be explained by means of an example of embodiment with reference to the drawing wherein

FIG. 1 schematically shows, in a longitudinal section, one half of a plate spiral distributor according to the state of the art for manufacturing nine layers in a film, and

FIG. 2 schematically shows, in an analogous view, a longitudinal section through a blowing head according to the invention.

The blowing head (1) (only partially shown) in FIG. 1 consists, among others, of a plate spiral distributor (2) with an extrusion axis (3). Nine spirals (A, B, C, D, E, F, G, H, J) are successively arranged on mutually parallel levels in the extrusion direction (4), with one spiral each being formed between a plate package 5 (numbered by way of example) of two superimposed plates (6, 7).

The spirals extend radially inward up to the extrusion axis (3) into an annular gap (8) leading to a tubular die (9).

During operation of the blowing head (1), melt streams produced by extruders (not shown) are conducted into the nine spirals, where they flow on one level, in parallel and separately from one another, towards the annular gap (8). In this way, a nine-layered film is produced in the annular gap (8). Starting with an input from the bottom spiral (J) into the annular gap (8), a one-layered melt stream is created which rises along the extrusion direction (4) through the annular gap (8). When the input from spiral (H) is reached, the melt stream supplied by spiral (H) is combined with the melt stream arriving only from spiral (J). Therefore, as of the input by spiral (H), there is a two-layered melt stream in the annular gap (8).

The two-layered melt stream flows further through the annular gap (8) in the extrusion direction (4), and when the level of spiral (G) is reached, a third layer is added, which is the melt stream flowing through the spiral (G).

This can already lead to a critical volume flow ratio; for two melt streams in the form of cylinder jacket-shaped layer streams arrive from below, whereas the melt stream coming from spiral (G) creates only one layer. In a simple case of identical volume flows of the melt streams through the spirals (G, H) and (J), the melt stream from spiral (G) thus merges with an arriving main melt stream with a volume flow which is twice as high.

This may in fact be desirable if the blowing head is suitably designed for a specific application; if, however, the melt stream arriving from spiral (G) is to be reduced e.g. for modification of the film or for an entirely different film, and if for instance in addition the volume flow of one or both melt streams from the spirals (H, J) is to be increased, e.g. because the layer created by spiral (G) is to become thinner and the other two layers are to become thicker, the possibilities of variation of conventional plate spiral distributors will quickly be exceeded.

The blowing head (10) according to the invention can be used much more flexibly:

The modified plate spiral distributor (11) disclosed herein is also adapted for outputting a nine-layered plastic film from the tubular die (9).

However, in this case, three superimposed spirals (A′, B′ and C′; D′, E′ and F′; G′, H′ and J′) each, forming parallel layers, are pre-combined before they reach the annular gap (8).

Thus, the innermost three layers of the final film are created during operation of the blowing head (10) according to the invention by the melt streams of the bottom modified spirals (G′, H′ and J′).

After a common spiral course (12) (which cannot be displayed, only numbered by way of example) of the spirals (G′, H′, J′), they have a first junction (13) forming three layers. From there, a common guide (14) leads to the annular gap (8).

This means that when the blown-film plant is operated with the blowing head (10) according to the invention, a three-layered melt stream is fed into the annular gap (8) at the very bottom.

This three-layered melt stream rises upward until it reaches a feeding height (15) of a next, second feed (16).

There as well, pre-combined melt streams from the spirals (D′, E′, F′) are input after they have already been combined to form three layers at a second junction (17).

Where the second feed (16) meets the arriving main flow in the annular gap (8), that is, at the feeding height (15), there is therefore an encounter of two three-layered streams. Modification of the volume flows of individual layers therefore has a much broader range of possibilities.

The same applies in an analogous manner to the last three melt streams from the spirals (A′, B′ and C′) which are also pre-combined at a third junction (18) before reaching the arriving main flow in the annular gap (8) via a third feed (19).

In the embodiment proposed here, first three melt streams each are pre-combined, and then the pre-combined three-layered melt streams are sequentially built up to form a nine-layered melt stream and consequently a nine-layered extruded film.

It is explicitly pointed out, however, that simpler or more complex junctions also form part of the inventive concept of first combining individual melt streams in a plate spiral distributor and then merging them to form a common co-extrusion flow.

Also, a blowing head according to the invention can be reduced in size as compared to the conventional form of construction.

This also reduces the length of the channel extending in the extruding direction and consequently the dwell time.

### REFERENCE NUMERALS

A′J spiral
A′-J′ modified spiral
1 blowing head
2 plate spiral distributor
3 extrusion axis
4 extrusion direction
5 plate package
6, 7 plates
8 annular gap
9 tubular die
10 blowing head according to the invention
11 modified plate spiral distributor
12 conventional spiral course
13 first junction
14 guide
15 feeding height
16 second feed
17 second junction
18 third junction
19 third feed

1. A blowing head for a blown-film plant, with a plate spiral distributor for distributing melt streams arriving from extruders and for combining the melt streams to form an annular gap stream in a plurality of layers in an annular gap leading to a tubular die, the plate spiral distributor having a plurality of spirals in superimposed layers, wherein the spirals of two layers have a junction for pre-combining the melt streams of two layers, and in that starting from the junction, a common guide leading to the annular gap is provided for combining the pre-combined melt streams with the annular gap stream.

2. The blowing head according to claim 1, wherein the spirals of two adjacent layers have a junction.

3. The blowing head according to claim 1, wherein the spirals of three layers have a junction.

4. The blowing head according to claim 1, further including a plurality of junctions having successive inputs to the annular gap.

5. The blowing head according to claim 1, wherein a plate has one spiral on a top side and one spiral on a bottom side.

6. The blowing head according to claim 5, wherein a plurality of plates have spirals on top sides and on the bottom sides.

7. A method for manufacturing a blown film with a blowing head according to claim 1, including the steps of conducting melt streams from extruders through the spirals, and pre-combining two melt streams in a junction, whereupon the pre-combined melt streams are conducted into the annular gap only in the further flow path and are merged there with the arriving annular gap stream.

8. The method according to claim 7, further including the step of pre-combining three melt streams in a junction, and providing an intermediate layer with two covering layers in the junction and conducting into the annular gap only in the covered state.

9. The method according to claim 8, further including the step of producing two covering layers with the same plastic.

10. A blown-film plant with extruders, a blowing head, a cooling device, a calibration unit, a lay-flat device, a reversing unit, if desired, and a winding station, wherein the blowing head is used and in that the blown-film plant is adapted to perform the method according to claim 7.
